(19) United States
(12) Patent Application Publication
(10) Pub. No.: US 2025/0006167 A1
(43) Pub. Date: Jan. 2, 2025

(54) IMAGE FORMING APPARATUS AND EJECTION SOUND SUPPRESSOR

(71) Applicant: FUJIFILM Business Innovation Corp., Tokyo (JP)

(72) Inventor: Satoshi FUKADA, Kanagawa (JP)

(73) Assignee: FUJIFILM Business Innovation Corp., Tokyo (JP)

(21) Appl. No.: 18/500,314

(22) Filed: Nov. 2, 2023

(30) Foreign Application Priority Data
Jun. 27, 2023 (JP) 2023-105321

(51) Int. Cl. G10K 11/172; G03G 15/00; G03G 21/16

(52) U.S. Cl. CPC G10K 11/172; G03G 15/6552; G03G 21/1619

(57) ABSTRACT

An image forming apparatus includes: a housing that has a forming section which is built therein and which forms an image on a recording medium, the housing having a medium placement section that is a bottom surface of a room, of which a front side in a backward direction is open, and an ejection port that ejects the recording medium, on which the image is formed, toward the room along a width direction intersecting with the backward direction; and a sound absorbing member that is provided on an upper wall covering the medium placement section from above in the housing and that has a first portion and a second portion which is positioned closer to the ejection port than the first portion and which has a larger vertical dimension than the first portion.

### CROSS-REFERENCE TO RELATED APPLICATIONS

This application is based on and claims priority under 35 USC 119 from Japanese Patent Application No. 2023-105321 filed Jun. 27, 2023.

### BACKGROUND

### (i) Technical Field

The present invention relates to an image forming apparatus and an ejection sound suppressor.

### (ii) Related Art

The image forming apparatus of JP2009-83957A includes: a sheet feeding device; a sheet transport passage for transporting a sheet which is fed from the sheet feeding device to each section of an apparatus body; and an image forming section that forms an image on the sheet which is transported through the sheet transport passage. In the image forming apparatus, there are provided a sound absorbing member and a sheet member. In the sound absorbing member, a plurality of ribs are provided so as to protrude from a sheet transport surface, on which a sheet transport passage is formed, along a transport direction, and the sound absorbing member fills at least a part of a gap between the ribs. The sheet member covers the sound absorbing member and the ribs.

### SUMMARY

An object of the present invention is to reduce sound which is transmitted to a user by leaking from an ejection port to the outside of the housing, as compared with a case where the sound absorbing member is provided only on the inside of the housing that is invisible to the user while the recording medium is being transported.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

Aspects of certain non-limiting embodiments of the present disclosure relate to an image forming apparatus including: a housing that has a forming section which is built therein and which forms an image on a recording medium, the housing having a medium placement section that is a bottom surface of a room, of which a front side in a backward direction is open, and an ejection port that ejects the recording medium, on which the image is formed, toward the room along a width direction intersecting with the backward direction; and a sound absorbing member that is provided on an upper wall covering the medium placement section from above in the housing and that has a first portion and a second portion which is positioned closer to the ejection port than the first portion and which has a larger vertical dimension than the first portion.

### BRIEF DESCRIPTION OF THE DRAWINGS

Exemplary embodiment(s) of the present invention will be described in detail based on the following figures, wherein:

FIG. 1 is a front view of the image forming apparatus according to the present exemplary embodiment;

FIG. 2 is a front view showing an upper part of the image forming apparatus in which a first downward extension portion, a second downward extension portion, and a sound reflection surface are omitted;

FIG. 3 is a cross-sectional view taken along the 3-3 arrow line of FIG. 1;

FIG. 4 is a cross-sectional view taken along the 4-4 arrow line of FIG. 3;

FIG. 5 is a cross-sectional view taken along the 5-5 arrow line of FIG. 1;

FIG. 6 is a cross-sectional view taken along the 6-6 arrow line of FIG. 5;

FIG. 7 is a schematic perspective view of a first rib and a first sound absorbing member;

FIG. 8 is a schematic perspective view of a second rib and a second sound absorbing member;

FIG. 9 is a first rib of a first modification example;

FIG. 10 is a first rib of a second modification example; and

FIG. 11 is a second rib of a third modification example.

### DETAILED DESCRIPTION

Hereinafter, exemplary embodiments of the invention will be described in detail with reference to the drawings. In the following description, an apparatus vertical direction (perpendicular direction), an apparatus width direction (horizontal direction), and an apparatus backward direction (backward direction) in a front view of an image forming apparatus 10 as seen from a side on which a user (not shown) stands will be referred to as an H direction, a W direction, and a D direction, respectively. Further, in a case where it is necessary to distinguish between one side and the other side in each of the apparatus vertical direction, the apparatus width direction, and the apparatus backward direction, an upper side, a lower side, a right side, a left side, a back side, and a front side in the front view of the image forming apparatus 10 will be referred to as a +H side, a −H side, a +W side, a −W side, a −D side, and a +D side, respectively.

### Overall Configuration of Image Forming Apparatus

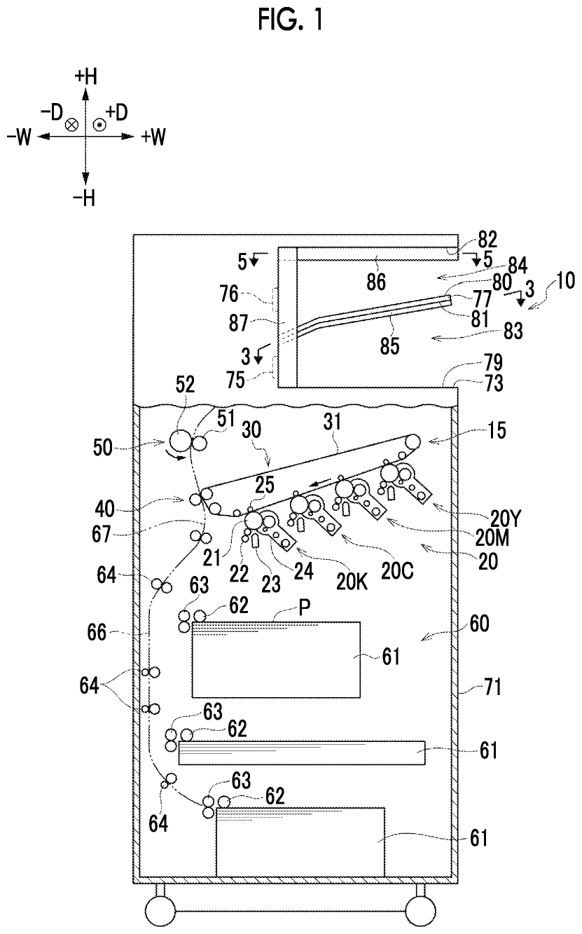

As shown in FIG. 1, the image forming apparatus 10 includes an image forming section (forming section) 15 and a body constituent section 70. The body constituent section 70 includes a housing 71 that constitutes a lower part thereof and a recessed portion 73 that constitutes an upper part thereof. The image forming section 15 is provided inside the housing 71.

### Image Forming Section 15

As shown in FIG. 1, the image forming section 15 includes a plurality of image creating devices 20 that form toner images with toners constituting a developer and an intermediate transfer device 30 that respectively holds the toner images formed by the respective image creating devices 20 and transports the toner images to a secondary transfer position for secondary transfer to a recording sheet (recording medium) P. Further, the image forming section 15 includes a sheet feeding device 60 that accommodates and transports the recording sheet P to be supplied to the secondary transfer position of the intermediate transfer device 30 and a fixing device 50 that fixes the toner images onto the recording sheet P which is secondarily transferred by the intermediate transfer device 30. The two-dot chain line in the drawing indicates a transport passage in which the recording sheet P is transported in the housing 71.

The image creating devices 20 include four image creating devices 20Y, 20M, 20C, and 20K that exclusively form toner images in four colors of yellow (Y), magenta (M), cyan (C), and black (K), respectively. The four image creating devices 20 (Y, M. C. K) are disposed in a row in a state of being inclined such that the yellow (Y) image creating device 20Y in the internal room of the housing 71 is positioned above the +W side along the W direction and the black (K) image creating device 20K is positioned below the-W side along the W direction. In addition, in a case where it is not necessary to distinguish the four colors, the four image creating devices 20 (Y, M. C. K) may be described as the image creating device 20, in which yellow (Y), magenta (M), cyan (C), and black (K) are omitted, or the image creating device 20 (Y, M. C. K).

Each image creating device 20 (Y, M. C. K) includes a photoconductor drum 21 rotating as an image holder. Around the photoconductor drum 21, the following are provided: a charging device 22 that charges a circumferential surface of the photoconductor drum 21; an exposure device 23 that forms an electrostatic latent image by irradiating the charged circumferential surface of the photoconductor drum 21 with light based on image information (signal); and a developing device 24 that develops the electrostatic latent images with toners of corresponding colors (Y, M. C. K) into toner images. Further, around the photoconductor drum 21, the following are provided: a primary transfer device 25 that transfers the toner images developed by the developing device 24 to the intermediate transfer device 30; and a photoconductor drum cleaning device 26 that removes and cleans deposits such as a toner that remains on the circumferential surface of the photoconductor drum 21 after the primary transfer. The primary transfer device 25 includes a primary transfer roll.

The intermediate transfer device 30 is disposed to be present at a position above each image creating device 20 (Y, M. C. K) in an H direction. The intermediate transfer device 30 includes an intermediate transfer belt 31 that rotates in the direction of the arrow while passing through the primary transfer position which is interposed between the photoconductor drum 21 and the primary transfer device 25, and a plurality of support rolls that rotatably supports the intermediate transfer belt 31 from an inner surface thereof. Further, the intermediate transfer device 30 includes a secondary transfer device 40 that is disposed on the outer circumferential surface side of the intermediate transfer belt 31 and that secondarily transfers the toner image on the intermediate transfer belt 31 to the recording sheet P.

The fixing device 50 includes a heating roll 51 that rotates and keeps the surface temperature at a predetermined temperature, and a pressure roll 52 that rotates around the driven axis in contact with the heating roll 51. The fixing device 50 heats and pressurizes the recording sheet P transported from the secondary transfer device 40, thereby fixing the toner image transferred to the recording sheet P to the recording sheet P.

The sheet feeding device 60 is disposed to be present at a position below the image creating device 20 (Y, M. C. K). The sheet feeding device 60 includes a plurality of sheet containers 61 that contains the recording sheet P having a predetermined size, type, and the like in a stacked state, and delivery devices 62 and 63 that delivers the recording sheet P one by one from the sheet containers 61.

A feeding transport passage 66 constituted of a single or a plurality of pairs of sheet transport rollers 64 that transport the recording sheet P delivered from the sheet feeding device 60 to the secondary transfer position and a transport guide (not shown in the drawing) is provided between the sheet feeding device 60 and the secondary transfer device 40. Further, a sheet transport passage 67 for transporting the recording sheet P after the secondary transfer to the fixing device 50 is provided between the secondary transfer device 40 and the fixing device 50. Further, a sheet ejection section (not shown in the drawing) for sending the recording sheet P after fixing to the first ejection port (ejection port) 75 and the second ejection port (ejection port) 76 to be described later is provided in a part of the housing 71 close to the first ejection port 75 and the second ejection port 76 to be described later. The sheet ejection section is able to send the recording sheet P to the first ejection port 75 and the second ejection port 76 while selecting the recording sheet P.

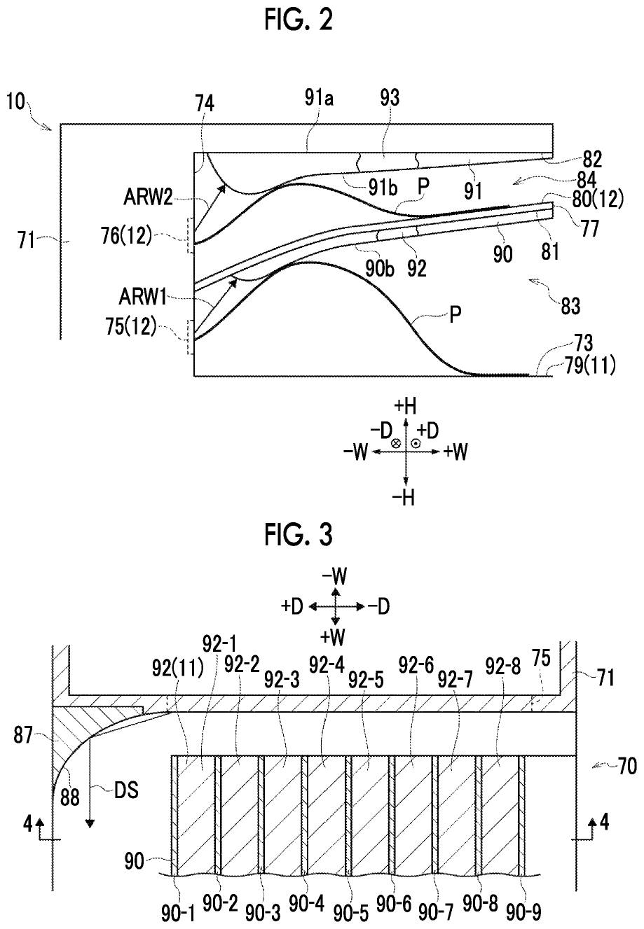

As shown in FIG. 1, the recessed portion 73 is formed above the housing 71. Both end portions of the recessed portion 73 in the D direction and the end portions in the +W direction are open. The housing 71 has a sheet ejection surface 74 that constitutes an end surface of the recessed portion 73 on the-W side. As shown in FIGS. 2, 4, and 6, the first ejection port 75 and the second ejection port 76, which both extend linearly in the D direction, are formed on the sheet ejection surface 74. The first ejection port 75 communicates an internal room of the housing 71 with an external room of the housing 71. The second ejection port 76 is positioned above the first ejection port 75. The end positions of the first ejection port 75 and the second ejection port 76 in the +D direction are identical to the end positions in the −D direction. As shown in FIGS. 1, 2, and 4, a base end portion of a tray 77, which is a plate-like member, is fixed in a portion between the first ejection port 75 and the second ejection port 76 on the sheet ejection surface 74. The front shape of the tray 77 is a substantially V shape. An end portion of the tray 77 in the +D direction is positioned closer to the +D side than the end portions of the first ejection port 75 and the second ejection port 76 in the +D direction, and an end portion of the tray 77 in the −D direction is positioned closer to the −D side than the end portions of the first ejection port 75 and the second ejection port 76 in the −D direction.

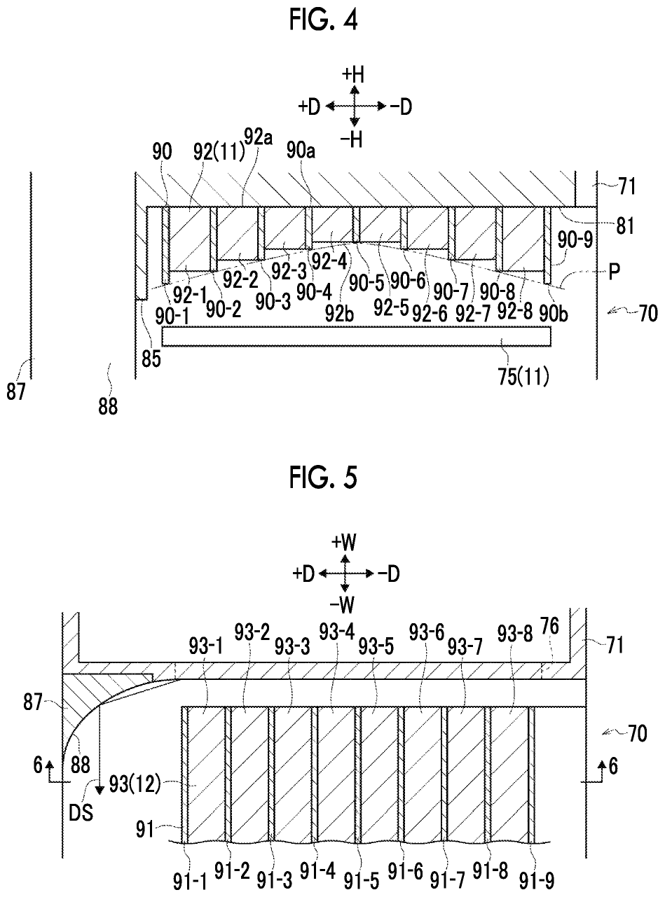

A lower surface of the recessed portion 73 is constituted of a first medium placement section (medium placement section) 79. An upper surface of the tray 77 is constituted of a second medium placement section (medium placement section) 80. A lower surface of the tray 77 is constituted of a first upper wall (upper wall) 81 facing the first medium placement section 79 from above. A ceiling surface of the recessed portion 73 is constituted of a second upper wall (upper wall) 82 facing the second medium placement section 80 from above. A room formed between the first medium placement section 79 and the first upper wall 81 is a first room (room) 83, and a room formed between the second medium placement section 80 and the second upper wall 82 is a second room (room) 84. As shown in FIGS. 1 and 4, a first downward extension portion (downward extension portion) 85 extending downward is provided on the entire edge portion of the tray 77 on the +D side. Further, a second downward extension portion (downward extension portion) 86 extending downward is provided on the entire edge portion of the second upper wall 82 on the +D side.

As shown in FIGS. 1 and 3 to 6, a reflection portion 87 is provided over the entire sheet ejection surface 74 in the H direction at an end portion of the sheet ejection surface 74 on the +D side. That is, the reflection portion 87 is positioned closer to the +D side than the first ejection port 75 and the second ejection port 76. A surface of the reflection portion 87 on the +W side (a surface on the +D side) is constituted of a sound reflection surface 88 formed as a curved surface which is closer to the +D side toward the +W direction.

As shown in FIG. 4, nine first ribs (ribs) 90 are integrally provided on the first upper wall 81 of the tray 77. In the following description, the respective first ribs 90 may be denoted by the reference numerals 90-1, 90-2, 90-3, 90-4, 90-5, 90-6, 90-7, 90-8, and 90-9 as shown in FIG. 4. The first rib 90-1, which is positioned closest to the +D side, and the first rib 90-9, which is positioned closest to the −D side, have an identical shape. The first rib 90-2, which is adjacent to the first rib 90-1 from the-D side, and the first rib 90-8, which is adjacent to the first rib 90-9 from the +D side, have an identical shape. The first rib 90-3, which is adjacent to the first rib 90-2 from the −D side, and the first rib 90-7, which is adjacent to the first rib 90-8 from the +D side, have an identical shape. The first rib 90-4, which is adjacent to the first rib 90-3 from the −D side, and the first rib 90-6, which is adjacent to the first rib 90-7 from the +D side, have an identical shape.

As shown in FIGS. 2 and 7, a front shape of an upper surface 90a of the first rib 90 is a substantially V shape. A position of a lower surface 90b of the first rib 90 in the H direction smoothly changes as a position of the first rib 90 in the W direction changes. More specifically, in a first region 90AR1 between the end portion of the first rib 90 in the +W direction and a position 90P shown in FIG. 7, a position of the lower surface 90b in the H direction is set to be gently lower toward the-W direction. In other words, in the first region 90AR1, a dimension of the first rib 90 in the H direction increases toward the −W direction. That is, an optional part of the first region 90AR1 is defined as a first portion (for example, the first portion 90P1 in FIG. 7), and an optional part, which is a part of the first region 90AR1 and is positioned closer to the first ejection port 75 than the first portion, is defined as a second portion (for example, the second portion 90P2 in FIG. 7). In such a case, a vertical dimension of the second portion is greater than a vertical dimension of the first portion. Further, in the second region AR2 between the position 90P of the first rib 90 and the end portion in the −W direction, the position of the lower surface 90b in the H direction is set to be gently higher toward the −W direction. In other words, in the second region 90AR2, the dimension of the first rib 90 in the H direction decreases toward the −W direction.

Further, as shown in FIG. 4, at each position along the W direction, the position of the lower surface 90b of each first rib 90 in the H direction is set to be gently lower toward the −W direction and the +W direction from the central portion in the W direction. That is, the position of the lower surfaces 90b of the first ribs 90-1 and 90-9 in the H direction is the lowermost position, and the position of the lower surface 90b of the first ribs 90-5 in the H direction is the uppermost position.

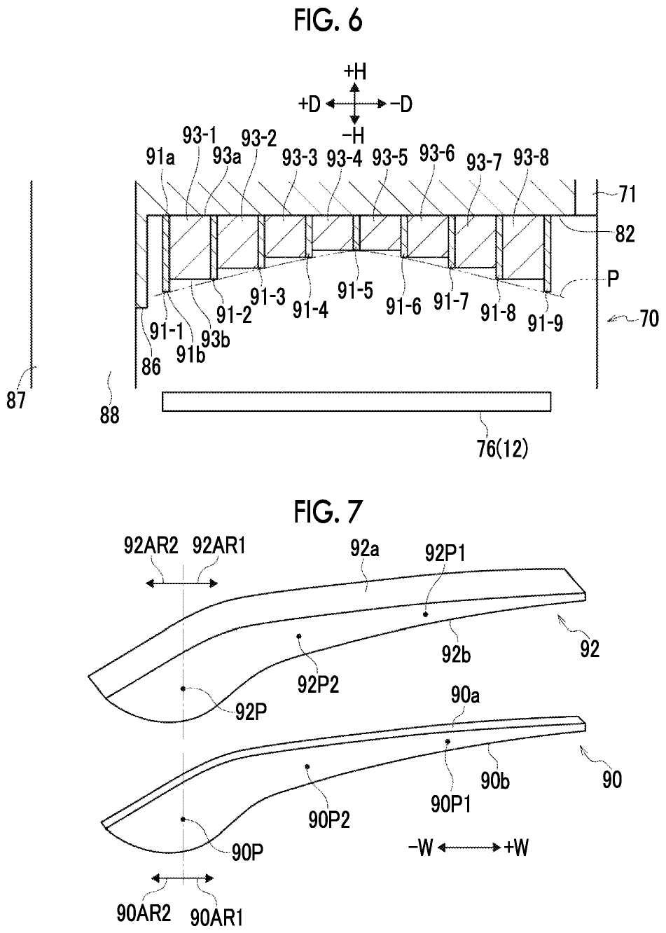

As shown in FIG. 6, nine second ribs (ribs) 91 are integrally provided on the second upper wall 82. In the following description, the respective second ribs 91 may be denoted by the reference numerals 91-1, 91-2, 91-3, 91-4, 91-5, 91-6, 91-7, 91-8, and 91-9 as shown in FIG. 4. The second rib 91-1, which is positioned closest to the +D side, and the second rib 91-9, which is positioned closest to the-D side, have an identical shape. The second rib 91-2. which is adjacent to the second rib 91-1 from the −D side, and the second rib 91-8, which is adjacent to the second rib 91-9 from the +D side, have an identical shape. The second rib 91-3, which is adjacent to the second rib 91-2 from the −D side, and the second rib 91-7, which is adjacent to the second rib 91-8 from the +D side, have an identical shape. The second rib 91-4, which is adjacent to the second rib 91-3 from the −D side, and the second rib 91-6, which is adjacent to the second rib 91-7 from the +D side, have an identical shape.

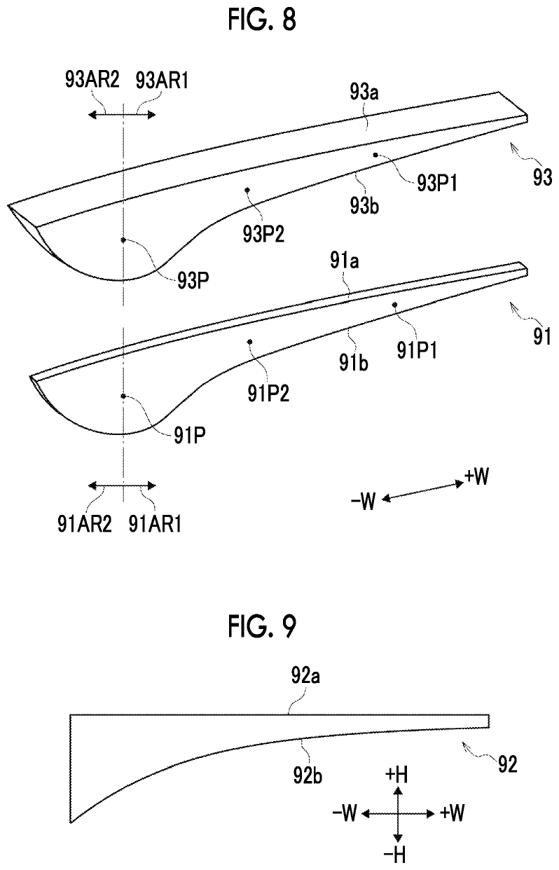

As shown in FIG. 8, the upper surface 91a of the second rib 91 is a plane orthogonal to the H direction. A position of the lower surface 91b of the second rib 91 in the H direction smoothly changes as the position of the second rib 91 in the W direction changes. More specifically, in a first region 91ARI between the end portion of the second rib 91 in the +W direction and a position 91P shown in FIG. 8, a position of the lower surface 91b in the H direction is set to be gently lower toward the-W direction. In other words, in the first region 91AR1, a dimension of the second rib 91 in the H direction increases toward the −W direction. That is, an optional part of the first region 91AR1 is defined as a first portion (for example, the first portion 91P1 in FIG. 8), and an optional part, which is a part of the first region 91AR1 and is positioned closer to the second ejection port 76 than the first portion, is defined as a second portion (for example, the second portion 91P2 in FIG. 8). In such a case, a vertical dimension of the second portion is greater than a vertical dimension of the first portion. Further, in the second region AR2 between the position 91P of the second rib 91 and the end portion in the −W direction, the position of the lower surface 91b in the H direction is set to be gently higher toward the-W direction. In other words, in the second region 91AR2, the dimension of the second rib 91 in the H direction decreases toward the-W direction.

Further, as shown in FIG. 6, at each position along the W direction, the position of the lower surface 91b of each second rib 91 in the H direction is set to be gently lower toward the −W direction and the +W direction from the central portion in the W direction. That is, the position of the lower surfaces 91b of the second ribs 91-1 and 91-9 in the H direction is the lowermost position, and the position of the lower surface 91b of the second ribs 91-5 in the H direction is the uppermost position.

As shown in FIGS. 3 and 4, eight first sound absorbing members (sound absorbing members) 92 are provided between the adjacent first ribs 90. The first sound absorbing member 92 is an integrally molded product made of urethane foam. In the following description, each first sound absorbing member 92 may be denoted by reference numerals 92-1. 92-2, 92-3, 92-4, 92-5, 92-6, 92-7, and 92-8. A dimension of the first sound absorbing member 92 in the D direction is greater than a dimension of the first rib 90. Each first sound absorbing member 92 has a front shape identical to the pair of adjacent first ribs 90 having a small dimension in the H direction. That is, the first sound absorbing members 92-1 and 92-8 have a front shape identical to the first ribs 90-2 and 90-8. The first sound absorbing members 92-2 and 92-7 have front shapes identical to the first ribs 90-3 and 90-7. The first sound absorbing members 92-3 and 92-6 have a shape identical to the first ribs 90-4 and 90-6. The first sound absorbing members 92-4 and 92-5 have a front shape identical to the first rib 90-5. That is, at each position along the W direction, dimensions of the first sound absorbing member 92-1 and the first sound absorbing member 92-8 in the H direction are greater than a dimension of the other first sound absorbing member 92 in the H direction. An upper surface 92a of each first sound absorbing member 92 is fixed onto the first upper wall 81, and both sides of each first sound absorbing member 92 in the D direction are fixed onto the pair of adjacent first ribs 90. At this time, a lower surface 92b of each first sound absorbing member 92 is continuous in the D direction with the lower surface of the adjacent rib which is one adjacent first rib 90. In addition, the lower surface 92b of each first sound absorbing member 92 at each position in the W direction coincides with the positions of the lower surfaces of the adjacent ribs in the vertical direction. That is, the lower surfaces 92b of the first sound absorbing members 92-1 and 92-8 are continuous with the lower surfaces 90b of the first ribs 90-2 and 90-8 in the D direction. The lower surfaces 92b of the first sound absorbing members 92-2 and 92-7 are continuous with the lower surfaces 90b of the first ribs 90-3 and 90-7 in the D direction. The lower surfaces 92b of the first sound absorbing members 92-3 and 92-6 are continuous with the lower surfaces 90b of the first ribs 90-4 and 90-6 in the D direction. The lower surfaces 92b of the first sound absorbing members 92-4 and 92-5 are continuous with the lower surface 90b of the first rib 90-5 in the D direction. Further, the lower surfaces 92b of the first sound absorbing members 92-1 and 92-8 are positioned closer to the +H side than the lower surfaces 90b of the first ribs 90-1 and 90-9. The lower surfaces 92b of the first sound absorbing members 92-2 and 92-7 are positioned closer to the +H side than the lower surfaces 90b of the first ribs 90-2 and 90-8. The lower surfaces 92b of the first sound absorbing members 92-3 and 92-6 are positioned closer to the +H side than the lower surfaces 90b of the first ribs 90-3 and 90-7. The lower surfaces 92b of the first sound absorbing members 92-4 and 92-5 are positioned closer to the +H side than the lower surfaces 90b of the first ribs 90-4 and 90-6. Further, as shown in FIG. 7, each first sound absorbing member 92 includes a first region 92AR1 (the region closer to the +W side than the position 92P in FIG. 7) corresponding to the first region 90AR1 and a second region 92AR2 corresponding to the second region 90AR2. Further, an optional part of the first region 92AR1 is defined as a first portion (for example, the first portion 92P1 in FIG. 7), and an optional part, which is a part of the first region 92AR1 and is positioned closer to the first ejection port 75 than the first portion, is defined as a second portion (for example, the second portion 92P2 in FIG. 7). In such a case, a vertical dimension of the second portion is greater than a vertical dimension of the first portion.

As shown in FIGS. 4 and 6, eight second sound absorbing members (sound absorbing members) 93 are provided between the adjacent second ribs 91. The second sound absorbing member 93 is an integrally molded product made of urethane foam. In the following description, each second sound absorbing member 93 may be denoted by reference numerals 93-1, 93-2, 93-3, 93-4, 93-5, 93-6, 93-7, and 93-8. A dimension of the second sound absorbing member 93 in the D direction is greater than a dimension of the second rib 91. Each second sound absorbing member 93 has a front shape identical to the pair of adjacent second ribs 91 having a smaller dimension in the H direction. That is, the second sound absorbing members 93-1 and 93-8 have a front shape identical to the second ribs 91-2 and 91-8. The second sound absorbing members 93-2 and 93-7 have front shapes identical to the second ribs 91-3 and 91-7. The second sound absorbing members 93-3 and 93-6 have a shape identical to the second ribs 91-4 and 91-6. The second sound absorbing members 93-4 and 93-5 have a front shape identical to the second rib 91-5. That is, at each position along the W direction, dimensions of the second sound absorbing member 93-1 and the second sound absorbing member 93-8 in the H direction are greater than a dimension of the other second sound absorbing member 93 in the H direction. An upper surface 93a of each second sound absorbing member 93 is fixed onto the second upper wall 82, and both sides of each second sound absorbing member 93 in the D direction are fixed onto the pair of adjacent second ribs 91. At this time, a lower surface 93b of each second sound absorbing member 93 is continuous in the D direction with the lower surface of the adjacent rib which is one adjacent second rib 91. In addition, the lower surface 93b of each second sound absorbing member 93 at each position in the W direction coincides with the positions of the lower surfaces of the adjacent ribs in the vertical direction. That is, the lower surfaces 93b of the second sound absorbing members 93-1 and 93-8 are continuous with the lower surfaces 91b of the second ribs 91-2 and 91-8 in the D direction. The lower surfaces 93b of the second sound absorbing members 93-2 and 93-7 are continuous with the lower surfaces 91b of the second ribs 91-3 and 91-7 in the D direction. The lower surfaces 93b of the second sound absorbing members 93-3 and 93-6 are continuous with the lower surfaces 91b of the second ribs 91-4 and 91-6 in the D direction. The lower surfaces 93b of the second sound absorbing members 93-4 and 93-5 are continuous with the lower surface 91b of the second rib 91-5 in the D direction. Further, the lower surfaces 93b of the second sound absorbing members 93-1 and 93-8 are positioned closer to the +H side than the lower surfaces 91b of the second ribs 91-1 and 91-9. The lower surfaces 93b of the second sound absorbing members 93-2 and 93-7 are positioned closer to the +H side than the lower surfaces 91b of the second ribs 91-2 and 91-8. The lower surfaces 93b of the second sound absorbing members 93-3 and 93-6 are positioned closer to the +H side than the lower surfaces 91b of the second ribs 91-3 and 91-7. The lower surfaces 93b of the second sound absorbing members 93-4 and 93-5 are positioned closer to the +H side than the lower surfaces 91b of the second ribs 91-4 and 91-6. Further, as shown in FIG. 8, each second sound absorbing member 93 includes a first region 93AR1 (the region closer to the +W side than the position 93P in FIG. 8) corresponding to the first region 91AR1 and a second region 93AR2 corresponding to the second region 91AR2. That is, an optional part of the first region 93AR1 is defined as a first portion (for example, the first portion 93P1 in FIG. 8), and an optional part, which is a part of the first region 93AR1 and is positioned closer to the second ejection port 76 than the first portion, is defined as a second portion (for example, the second portion 93P2 in FIG. 8). In such a case, a vertical dimension of the second portion is greater than a vertical dimension of the first portion.

In the configuration described above, the first ejection port 75, the first medium placement section 79, and the first sound absorbing member 92 are constituent elements of the first ejection sound suppressor (ejection sound suppressor) 11, and the second ejection port 76, the second medium placement section 80, and the second sound absorbing member 93 are constituent elements of the second ejection sound suppressor (ejection sound suppressor) 12.

Next, operations of the image forming apparatus 10 having the above-mentioned configuration will be described.

For example, in a case where the recording sheet P on which the image is formed is sent to the first ejection port 75 by the sheet ejection section, the recording sheet P is ejected from the first ejection port 75 to the first room 83. At this time, as shown in FIG. 3, the recording sheet P also moves downward due to gravity in contact with the lower surface 90b of each first rib 90, and is finally loaded on the first medium placement section 79. Further, in a case where the recording sheet P on which the image is formed is sent to the second ejection port 76 by the sheet ejection section, the recording sheet P is ejected from the second ejection port 76 to the second room 84. At this time, as shown in FIG. 2, the recording sheet P moves downward due to gravity in contact with the lower surface 91b of each of the second ribs 91, and is finally loaded on the second medium placement section 80.

Meanwhile, operation sounds of the image creating device 20, the intermediate transfer device 30, the secondary transfer device 40, the fixing device 50, and the sheet feeding device 60 leak from the first ejection port 75 to the first room 83. However, the image forming apparatus 10 has a plurality of first sound absorbing members 92. Therefore, each of the first sound absorbing members 92 absorbs a part of the sound which leaks from the first ejection port 75 to the first room 83. As indicated by the arrow ARW1 in FIG. 3, a part of the sound, which leaks from the first ejection port 75, passes between the end portions on the −W side of each of the first ribs 90 and is absorbed by the end portion of each of the first sound absorbing members 92 on the −W side.

The sound, which leaks from the first ejection port 75 to the first room 83, propagates in the +W direction while being attenuated. That is, the sound passing through a region close to the first ejection port 75 is likely to be louder than the sound passing through a region away from the first ejection port 75 in the +W direction. In the first region 92AR1 of the first sound absorbing member 92 of the present exemplary embodiment, the position of the lower surface 92b in the H direction gradually decreases toward the-W direction. In other words, in the first region 92AR1, a dimension of the first sound absorbing member 92 in the H direction increases toward the-W direction. The larger the volume of the sound absorbing member, the easier it is for the sound absorbing member to exhibit high sound absorbing performance. Therefore, compared to a case where the position of the first region 92AR1 in the H direction is constant regardless of the position in the W direction, the first sound absorbing member 92 is more likely to absorb the sound passing through the region close to the first ejection port 75. Therefore, in the image forming apparatus 10 of the present exemplary embodiment, compared to a case where the sound absorbing member is provided only inside the housing 71, it is possible to reduce the sound transmitted to a user from the first ejection port 75 to the outside of the housing 71.

Similarly, in the first region 93AR1 of the second sound absorbing member 93 of the present exemplary embodiment, the position of the lower surface 93b in the H direction gradually decreases toward the-W direction. In other words, in the first region 93AR1, the dimension of the second sound absorbing member 93 in the H direction increases toward the -W direction. Therefore, compared to a case where the position of the first region 93AR1 in the H direction is constant regardless of the position in the W direction, the second sound absorbing member 93 is more likely to absorb the sound passing through the region close to the second ejection port 76. Therefore, in the image forming apparatus 10 of the present exemplary embodiment, compared to a case where the sound absorbing member is provided only inside the housing 71, it is possible to reduce the sound which leaks from the second ejection port 76 and to the outside of the housing 71 and transmitted to a user.

Further, a vertical dimension of the first sound absorbing member 92-1 positioned on the +D side (front side) of the first sound absorbing members 92 is largest among all the first sound absorbing members 92. More specifically, the vertical dimensions of the first sound absorbing member 92-1, which is positioned closest to the +D side (front side), and the first sound absorbing member 92-8, which is positioned closest to the −D side (back side), are greater than the vertical dimension of the first sound absorbing member 92. Therefore, compared to a case where the vertical dimension of the first sound absorbing member 92-1, which is positioned closest to the +D side (front side), is equal to or smaller than the vertical dimension of the other first sound absorbing member 92 excluding the first sound absorbing member 92-8, it is possible to reduce the sound which leaks from the first ejection port 75 to the outside of the housing 71 and is transmitted to a user. Similarly, the vertical dimension of the second sound absorbing member 93-1, which is positioned closest to the +D side (front side), of the second sound absorbing members 93 is largest among all the second sound absorbing members 93. More specifically, the vertical dimensions of the second sound absorbing member 93-1, which is positioned closest to the +D side (front side), and the second sound absorbing member 93-8, which is positioned closest to the −D side (back side), are greater than the vertical dimension of the second sound absorbing member 93. Therefore, compared to a case where the vertical dimension of the second sound absorbing member 93, which is positioned closest to the +D side (front side), is equal to or smaller than the vertical dimension of the other second sound absorbing member 93 excluding the second sound absorbing member 93-8, it is possible to reduce the sound which leaks from the second ejection port 76 to the outside of the housing 71 and is transmitted to a user.

Further, a first downward extension portion 85 extending downward is provided at an end portion of the first upper wall 81 on the +D side (front side), and a second downward extension portion 86 extending downward is provided at an end portion of the second upper wall 82 on the +D side. Therefore, compared to a case where the entire first upper wall 81 and the entire second upper wall 82 are formed as flat surfaces, the sound, which leaks from the first ejection port 75 and the second ejection port 76 to the outside of the housing 71 and is transmitted to the user, is reduced.

Further, the housing 71 is positioned closer to the +D side (front side) than the first ejection port 75 and the second ejection port 76, and includes a sound reflection surface 88 formed as a curved surface which is closer to the +D side toward the +W direction. Therefore, for example, the sound reflection surface 88 in the direction of an arrow DS in FIGS. 3 and 5 reflects the sound emitted from the first ejection port 75 and the second ejection port 76. That is, the sound reflection surface 88 regulates propagation of a part of the sound emitted from the first ejection port 75 and the second ejection port 76 toward the +D side where the user is present. Therefore, compared to a case where the entire first upper wall 81 and the entire second upper wall 82 are formed as flat surfaces, the sound, which leaks from the first ejection port 75 and the second ejection port 76 to the outside of the housing 71 and is transmitted to the user, is reduced.

Further, the recording sheet P, which is ejected from the first ejection port 75 to the first room 83, moves in the +W direction in contact with the lower surface 90b of each first rib 90, and the recording sheet P, which is ejected from the second ejection port 76 to the second room 84, moves in the +W direction in contact with the lower surface 91b of each of the second ribs 91. Therefore, compared to a case where the entire first upper wall 81 and the entire second upper wall 82 are formed as a flat surface, the recording sheets P, which are ejected from the first ejection port 75 and the second ejection port 76, tend to smoothly move in the +W direction.

Further, the position of the lower surface 90b of the first rib 90 in the H direction smoothly changes as the position of the first rib 90 in the W direction changes. Similarly, the position of the lower surface 91b of the second rib 91 in the H direction smoothly changes as the position of the second rib 91 in the W direction changes. Therefore, compared to a case where the positions of the lower surfaces 90b and 91b in the H direction change stepwise as the positions of the first rib 90 and the second rib 91 in the W direction change, the recording sheets P, which are ejected from the first ejection port 75 and the second ejection port 76, tend to smoothly move in the +W direction.

Further, the lower surface 92b of each first sound absorbing member 92 is continuous with the lower surface 90b of one adjacent first rib 90 (adjacent rib) in the D direction (backward direction), and the position of the lower surface 92b of each first sound absorbing member 92 coincides with the position of the lower surface 90b of the adjacent rib, in the vertical direction, at each position in the W direction. Similarly, the lower surface 93b of each second sound absorbing member 93 is continuous with the lower surface 91b of one adjacent second rib 91 (adjacent rib) in the D direction (backward direction), and the position of the lower surface 93b of each second sound absorbing member 93 coincides with the lower surface 91b of the adjacent rib, in the vertical direction, at each position in the W direction. Therefore, while preventing the first sound absorbing member 92 and the second sound absorbing member 93 from hindering the movement of the recording sheet P in the +W direction, it is possible to enhance the sound absorbing effect of the first sound absorbing member 92 and the second sound absorbing member 93, as compared with a case where the lower surfaces 92b and 93b of the first sound absorbing member 92 and the second sound absorbing member 93 are positioned above the lower surfaces 90b and 91b of the adjacent ribs 90 and 91.

Further, at each position along the W direction, the position of the lower surface 92bof each first sound absorbing member 92 in the vertical direction is positioned to be identical to the positions of the lower surfaces 90b of the pair of adjacent first ribs 90 or above the positions of the lower surfaces 90b. Therefore, the first sound absorbing member 92 is prevented from hindering the movement of the recording sheet P ejected from the first ejection port 75 in the +W direction. Therefore, at each position along the W direction, the recording sheet P ejected from the first ejection port 75 tends to smoothly move in the +W direction, as compared with a case where the lower surface 92b of the first sound absorbing member 92 in the vertical direction is positioned below the lower surfaces 90b of the pair of first ribs 90 adjacent to each other. Similarly, at each position along the W direction, the position of the lower surface 93b of each second sound absorbing member 93 in the vertical direction is positioned to be identical to the positions of the lower surfaces 91b of the pair of adjacent second ribs 91 or above the positions of the lower surfaces 91b. Therefore, the second sound absorbing member 93 is prevented from hindering the movement of the recording sheet P ejected from the second ejection port 76 in the +W direction. Therefore, at each position along the W direction, the recording sheet P ejected from the second ejection port 76 tends to smoothly move in the +W direction, as compared with a case where the lower surface 93b of the second sound absorbing member 93 in the vertical direction is positioned below the lower surfaces 91b of the pair of second ribs 91 adjacent to each other.

Further, as shown in FIGS. 4 and 6, in each position along the W direction, the positions of the lower surfaces 90b and 91b of the first rib 90 and the second rib 91 in the vertical direction are set to be gently lower toward the end portion on the-D side (back side) and the end portion on the +D side (front side) from the central portion in the D direction (backward direction). Therefore, as shown in FIGS. 4 and 6, as viewed along the W direction, the recording sheet P ejected from the first ejection port 75 moves in the +W direction while being gently curved, and the recording sheet P ejected from the second ejection port 76 moves in the +W direction while being gently curved. Therefore, at each position along the W direction, the recording sheet P ejected from the first ejection port 75 and the second ejection port 76 tends to smoothly move in the +W direction, as compared with a case where the lower surfaces 90b and 91b of the first rib 90 and the second rib 91 have an identical position in the vertical direction.

The image forming apparatus 10 according to the present exemplary embodiment has been described above with reference to the drawings, but the image forming apparatus 10 according to the present exemplary embodiment is not limited to the apparatus shown in the drawings. The design of the image forming apparatus 10 can be changed as appropriate without departing from the scope of the present invention.

Similarly to the first modification example shown in FIG. 9, the lower surface 92b of the first sound absorbing member 92 may have a shape that is positioned gradually closer to the-H side toward the-W direction. Although not shown, the lower surface 93b of the second sound absorbing member 93 may have a shape such that the lower surface 93b is positioned gradually closer to the-H side toward the-W direction.

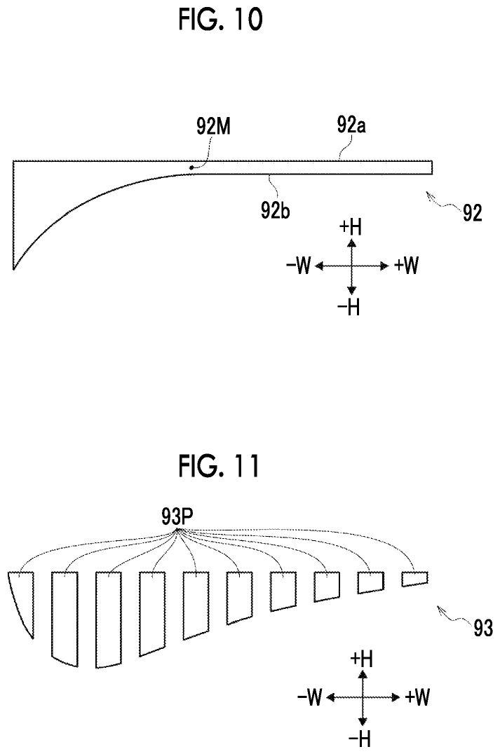

Similarly to the second modification example shown in FIG. 10, the lower surface 92b of the first sound absorbing member 92 in the region positioned in the +W direction from the intermediate portion 92M in the W direction may be parallel to the W direction. In addition, the lower surface in the region positioned in the −W direction from the intermediate portion 92M may be positioned closer to the-H side toward the −W direction. Although not shown, the lower surface of the second sound absorbing member 93 in the region positioned in the +W direction from the intermediate portion in the W direction may be parallel to the W direction, and the lower surface in the region positioned in the-W direction from the intermediate portion may be positioned closer to the-H side toward the-W direction.

For example, as shown in FIG. 11, the second sound absorbing member 93 may be constituted of a plurality of portions 93P separated from each other. Although not shown, the first sound absorbing member 92 may be constituted of a plurality of portions separated from each other.

Although not shown, the positions of the lower surfaces of the first sound absorbing member 92 and the second sound absorbing member 93 in the H direction may change stepwise as the positions in the W direction change.

The housing 71 may include only one of the first ejection port 75 and the second ejection port 76. In such a case, the housing 71 includes only one medium placement section and one upper wall.

Further, the housing 71 may include three or more ejection ports. In such a case, the housing 71 includes three or more medium placement sections and three or more upper walls.

The number of ribs and sound absorbing members provided on one upper wall may be different from the number in the exemplary embodiments. For example, only one rib and one sound absorbing member may be provided on one upper wall.

All the shapes of the plurality of ribs provided on one upper wall may be completely identical, and the shape of the sound absorbing member provided between the adjacent ribs as viewed in the D direction may be identical to each rib.

Only the dimensions of the sound absorbing members (first sound absorbing member 92-1, second sound absorbing member 93-1) in the H direction, which are positioned closest to the +D side (front side), may be greater than the dimension in the H direction of the other sound absorbing members.

In a case where a plurality of sound absorbing members are provided on one upper wall, the lower surfaces of all the sound absorbing members may be positioned above the lower surfaces of the pair of adjacent ribs.

The housing 71 does not have to include at least one of an extension portion or a sound reflection surface.

The position of the lower surface of the sound absorbing member in the H direction may change stepwise as the position of the sound absorbing member in the W direction changes.

The sound absorbing member may be made of a non-woven fabric.

The recording medium may be a medium different from the recording sheet P. For example, the recording medium may be a transparent film.

The image forming apparatus may be an ink type image forming apparatus.

### Supplementary Note

(((1)))

An image forming apparatus comprising:

a housing that has a forming section which is built therein and which forms an image on a recording medium, the housing having a medium placement section that is a bottom surface of a room, of which a front side in a backward direction is open, and an ejection port that ejects the recording medium, on which the image is formed, toward the room along a width direction intersecting with the backward direction; and a sound absorbing member that is provided on an upper wall covering the medium placement section from above in the housing and that has a first portion and a second portion which is positioned closer to the ejection port than the first portion and which has a larger vertical dimension than the first portion.

(((2)))

The image forming apparatus according to (((1))), further comprising:

a plurality of ribs that protrude downward from the upper wall to be aligned in the backward direction; and

a plurality of sound absorbing members that are each provided between two adjacent ribs of the ribs.

(((3)))

The image forming apparatus according to (((1))) or (((2))),

wherein as positions of the ribs in the width direction change, shapes of lower surfaces of the ribs change smoothly.

(((4)))

The image forming apparatus according to (((2))) or (((3))),

wherein a lower surface of the sound absorbing member is continuous, in the backward direction, with a lower surface of an adjacent rib as at least one of the ribs to which the lower surface of the sound absorbing member is adjacent, and a position of the lower surface of the sound absorbing member in a vertical direction coincides with a position of the lower surface of the adjacent rib in the vertical direction, at each position thereof in the width direction.

(((5)))

The image forming apparatus according to any one of (((2))) to (((4))),

wherein at each position along the width direction, a position of a lower surface of each sound absorbing member in the vertical direction is identical to positions of lower surfaces of a pair of the adjacent ribs or above the positions of the lower surfaces of the pair of the adjacent ribs in the vertical direction.

(((6)))

The image forming apparatus according to any one of (((2))) to (((5))),

wherein at each position along the width direction, a position of a lower surface of each rib in a vertical direction is set to be gently lower toward an end portion on a back side and an end portion on the front side in the backward direction from a central portion in the backward direction.

(((7)))

The image forming apparatus according to any one of (((1))) to (((6))),

wherein the vertical dimension of the sound absorbing member positioned closest to the front side is largest among all the sound absorbing members.

(((8)))

The image forming apparatus according to any one of (((1))) to (((7))),

wherein the ejection port has a first ejection port and a second ejection port positioned below the first ejection port,

the medium placement section supports a first medium placement section that supports the recording medium ejected from the first ejection port from below, and a second medium placement section that supports the recording medium ejected from the second ejection port from below,

the upper wall has a first upper wall that covers the first medium placement section from above, and a second upper wall that covers the second medium placement section from above, and

the sound absorbing member has a first sound absorbing member that is fixed onto the first upper wall and a second sound absorbing member that is fixed onto the second upper wall.

(((9)))

The image forming apparatus according to any one of (((1))) to (((8))),

wherein a downward extension portion which extends downward is provided at an end portion of the upper wall on the front side.

(((10)))

The image forming apparatus according to any one of (((1))) to (((9))),

wherein the housing includes a sound reflection surface that is positioned closer to the front side than the ejection port and that is formed as a curved surface which is closer to the front side toward the width direction. (((11)))

An ejection sound suppressor comprising:

a sound absorbing member that is provided on an upper wall covering the medium placement section from above in a housing that has a forming section which is built therein and that forms an image on a recording medium and that has a medium placement section which is a bottom surface of a room of which a front side in a backward direction is open and an ejection port that ejects the recording medium, on which the image is formed, toward the room along a width direction intersecting with the backward direction, and that has a first portion and a second portion which is positioned closer to the ejection port than the first portion and which has a larger vertical dimension than the first portion.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a housing that has a forming section which is built therein and which forms an image on a recording medium, the housing having a medium placement section that is a bottom surface of a room, of which a front side in a backward direction is open, and an ejection port that ejects the recording medium, on which the image is formed, toward the room along a width direction intersecting with the backward direction; and
a sound absorbing member that is provided on an upper wall covering the medium placement section from above in the housing and that has a first portion and a second portion which is positioned closer to the ejection port than the first portion and which has a larger vertical dimension than the first portion.

2. The image forming apparatus according to claim 1, further comprising:
a plurality of ribs that protrude downward from the upper wall to be aligned in the backward direction; and
a plurality of sound absorbing members that are each provided between two adjacent ribs of the ribs.

3. The image forming apparatus according to claim 2, wherein as positions of the ribs in the width direction change, shapes of lower surfaces of the ribs change smoothly.

4. The image forming apparatus according to claim 3,
wherein a lower surface of the sound absorbing member is continuous, in the backward direction, with a lower surface of an adjacent rib as at least one of the ribs to which the lower surface of the sound absorbing member is adjacent, and a position of the lower surface of the sound absorbing member in a vertical direction coincides with a position of the lower surface of the adjacent rib in the vertical direction, at each position thereof in the width direction.

5. The image forming apparatus according to claim 2,
wherein at each position along the width direction, a position of a lower surface of each sound absorbing member in the vertical direction is identical to positions of lower surfaces of a pair of the adjacent ribs or above the positions of the lower surfaces of the pair of the adjacent ribs in the vertical direction.

6. The image forming apparatus according to claim 3,
wherein at each position along the width direction, a position of a lower surface of each sound absorbing member in the vertical direction is identical to positions of lower surfaces of a pair of the adjacent ribs or above the positions of the lower surfaces of the pair of the adjacent ribs in the vertical direction.

7. The image forming apparatus according to claim 2,
wherein at each position along the width direction, a position of a lower surface of each rib in a vertical direction is set to be gently lower toward an end portion on a back side and an end portion on the front side in the backward direction from a central portion in the backward direction.

8. The image forming apparatus according to claim 3,
wherein at each position along the width direction, a position of a lower surface of each rib in a vertical direction is set to be gently lower toward an end portion on a back side and an end portion on the front side in the backward direction from a central portion in the backward direction.

9. The image forming apparatus according to claim 7,
wherein the vertical dimension of the sound absorbing member positioned closest to the front side is largest among all the sound absorbing members.

10. The image forming apparatus according to claim 8,
wherein the vertical dimension of the sound absorbing member positioned closest to the front side is largest among all the sound absorbing members.

11. The image forming apparatus according to claim 2,
wherein the ejection port has a first ejection port and a second ejection port positioned below the first ejection port, the medium placement section supports a first medium placement section that supports the recording medium ejected from the first ejection port from below, and a second medium placement section that supports the recording medium ejected from the second ejection port from below,
the upper wall has a first upper wall that covers the first medium placement section from above, and a second upper wall that covers the second medium placement section from above, and
the sound absorbing member has a first sound absorbing member that is fixed onto the first upper wall and a second sound absorbing member that is fixed onto the second upper wall.

12. The image forming apparatus according to claim 3,
wherein the ejection port has a first ejection port and a second ejection port positioned below the first ejection port,
the medium placement section supports a first medium placement section that supports the recording medium ejected from the first ejection port from below, and a second medium placement section that supports the recording medium ejected from the second ejection port from below,
the upper wall has a first upper wall that covers the first medium placement section from above, and a second upper wall that covers the second medium placement section from above, and
the sound absorbing member has a first sound absorbing member that is fixed onto the first upper wall and a second sound absorbing member that is fixed onto the second upper wall.

13. The image forming apparatus according to claim 1,
wherein a downward extension portion which extends downward is provided at an end portion of the upper wall on the front side.

14. The image forming apparatus according to claim 2,
wherein a downward extension portion which extends downward is provided at an end portion of the upper wall on the front side.

15. The image forming apparatus according to claim 1,
wherein the housing includes a sound reflection surface that is positioned closer to the front side than the ejection port and that is formed as a curved surface which is closer to the front side toward the width direction.

16. The image forming apparatus according to claim 2,
wherein the housing includes a sound reflection surface that is positioned closer to the front side than the ejection port and that is formed as a curved surface which is closer to the front side toward the width direction.

17. An ejection sound suppressor comprising:
a sound absorbing member that is provided on an upper wall covering the medium placement section from above in a housing that has a forming section which is built therein and that forms an image on a recording medium and that has a medium placement section which is a bottom surface of a room of which a front side in a backward direction is open and an ejection port that ejects the recording medium, on which the image is formed, toward the room along a width direction intersecting with the backward direction, and that has a first portion and a second portion which is positioned closer to the ejection port than the first portion and which has a larger vertical dimension than the first portion.
